(19) United States
(12) Patent Application Publication
(10) Pub. No.: US 2013/0300787 A1
(43) Pub. Date: Nov. 14, 2013

(54) DEVICE AND METHOD FOR PRINTING MAILPIECES

(71) Applicant: BOEWE SYSTEC GMBH, Augsburg (DE)

(72) Inventor: Heiner KUDRUS, Eupen (BE)

(73) Assignee: BOEWE SYSTEC GmbH, Augsburg (DE)

(21) Appl. No.: 13/828,612

(22) Filed: Mar. 14, 2013

(30) Foreign Application Priority Data
May 11, 2012 (DE) 102012104154.7

(51) Int. Cl. G07B 17/00

(52) U.S. Cl. CPC G07B 17/00185
USPC 347/9

(57) ABSTRACT

A device including a printer with a print head for printing an imprint containing a first printing area with a security imprint (such as a franking mark), and a second printing area with a text or image imprint on mailpieces. The print head has at least two printing nozzles, of which a first printing nozzle is connected to a first printing supply and a second printing nozzle is connected to a second printing supply. An ink suitable for a security imprint is contained in the first printing supply, and a conventional printing ink is contained in the second printing supply. In the related method, the entire imprint, which contains a first printing area with a security imprint and a second printing area with a text or image imprint, is printed onto the mailpiece in a single print run.

### CROSS REFERENCE TO RELATED APPLICATIONS

This application claims priority under 35 U.S.C. §119 to German Patent Application No. 10 2012 104 154.7 filed 11 May 2012, the entire contents of which are incorporated herein by reference.

### FIELD OF THE INVENTION

The invention relates to a device for printing mailpieces and a method for printing mailpieces with an imprint that contains a first printing area with a security imprint and a second printing area with a text or graphical imprint.

### BACKGROUND OF THE INVENTION

The security imprint can be a franking mark, for example, a bar code, a forgery-proof identification mark or the like. Special and possibly also certified inks are ordinarily used for printing such security imprints. For the franking imprint on a mailpiece, for example, it is typical to use special inks that are suitable for printing the franking mark on a mailpiece with inkjet printers and are approved or certified by the postal authorities. Such inks for printing a franking mark are known from the prior art, e.g. from EP 1072653 A2, EP 1085059-A, EP 0779348-A and WO 2001/057146-A.

Franking machines are normally used for printing a franking mark on a plurality of mailpieces. For this purpose, modern franking machines have a digital printing unit with which special ink suitable for printing a franking mark on the mailpieces can be processed. With such digital franking machines, it is possible to print any desired texts or images on the mailpieces instead of or in addition to a franking mark.

For example, a mail processing system is known from EP 0901109 A2, with a franking and addressing machine having a single print head with which both a franking mark and an address in text form can be printed on a mailpiece. The mail processing system be used either as a pure franking system or as a pure addressing system or in combination as a franking and addressing system. Combined address printing and franking printing takes two print runs. A control unit for the franking and addressing machine is connected to a rotary station for this purpose. In order to print both a franking mark and an address, the mailpieces to be printed are first run past the single print head of the printing device in a first pass in order to print the address onto the mailpiece. Then the mailpiece to be printed is rotated by means of the rotary station and thereafter, now in a rotated position, run past the single print head in order to print the franking mark in a second print run.

This known mail processing system has the following disadvantages.

Firstly, the production and control of this mail processing system is expensive and maintenance-intensive due to the technically elaborate rotary station. The throughput of this known mail processing system is also relatively low, which is why such a mail processing system is not suitable for printing mass mailings, for example. Secondly the same ink as for printing the franking mark is used for printing the address imprint in the known processing machine. As already mentioned above, however, special inks, such as fluorescent inks, are used for printing a franking mark for security reasons and due to postal regulations. These inks are very expensive, however. If the expensive special ink suitable for a franking mark is also used in the known mail processing system for printing the address, the imprint becomes more expensive due to a very high consumption of the expensive franking ink.

### SUMMARY OF THE INVENTION

Starting from this point, embodiments of the invention address the problem of specifying a device and a method for quickly and economically printing an imprint on mailpieces that includes both a security imprint such as a franking mark and a conventional text or image imprint. The device according to embodiments of the invention is also intended to be integrated in the simplest possible manner into mail processing systems for processing mass mailings.

The device according to the invention contains a printer with a single print head with which imprints can be printed on mailpieces, wherein this imprint comprises a first printing area with a security imprint and a second printing area with a conventional text or image imprint. The security imprint can be, in particular, a franking mark or a different type of security imprint such as a security bar code or a counterfeit-proof identification mark. Security imprint is understood in this context to mean those imprints which, according to security regulations or official specifications, must be counterfeit-proof and therefore must be printed with a special printing means (printing ink) for printing such a security imprint. The conventional text or image imprint can be an address printed in ASCII code or a pattern imprint that contains pictorial elements (e.g. the logo of the sender of a mailpiece or decorative pictorial motifs). The conventional text or image imprint can also contain a code, e.g., a bar code, but one which is not subject to special security conditions or need not be counterfeit-proof as is the case with security imprint. A component of the text or image imprint can also be a so-called transpromo imprint, which is used for sales and promotional purposes in the sending of mailpieces containing transaction documents such as bills or account statements. In a transpromo imprint, advertising messages are printed on remaining blank areas of the transaction document or the envelope in which it is sent (also referred to as “white space management”).

The print head of the device according to the invention has at least two printing nozzles, of which a first printing nozzle is connected to a first printing means supply and a second printing nozzle is connected to a second printing means supply, the first printing means supply and the second printing means supply being separate from one another. An ink suitable for or specially certified for a security imprint is contained in the first printing means supply, and a conventional printing ink that is used in conventional inkjet printers, for example, is contained in the second printing means supply.

This configuration of the print head makes it possible to print the first printing region with the security imprint and the second printing region with the text or image imprint onto a mailpiece in a single print run. The entire imprint, which is composed of the first printing region and the second printing region, can be printed simultaneously onto the mailpieces with the devices according to the invention. The printing nozzles of the print head are controlled appropriately by the control unit for this purpose, so that the first printing nozzle prints the security imprint at the same time the second printing nozzle or any additional printing nozzles that may be present print the text or image imprint onto the mailpieces.

In order to comply with the security requirements for printing the security imprint, which are required when printing a franking mark, for example, the first printing nozzle and the second printing nozzle (and any additional printing nozzles) are controlled separately by the control unit. The first printing nozzle, which is connected to the first printing means supply for a security imprint, is advantageously coupled to a first data processing unit for this purpose. The technical functionality of a franking machine is implemented in this first data processing unit. In particular, the first data processing unit comprises one or more counting means and a postage loading unit.

The second printing nozzle and any additional printing nozzles present in the print head are expediently coupled to a second data processing unit, which is in turn decoupled from the first data processing unit. From the second data processing unit, the second printing nozzle and any additional printing nozzles receive the printing data for printing the text or image imprint, which is printed with the second printing nozzle or any additional printing nozzles.

The print head is expediently an inkjet print head with several printing nozzles, one of these printing nozzles being connected to the first printing means supply for a security imprint, and the other printing nozzle being connected to a printing means supply with conventional printing ink. For example, the print head can be an inkjet print head with a total of four printing nozzles wherein the first printing nozzle is connected to the printing means supply for the security imprint, and the three additional printing nozzles are connected to a printing means supply containing conventional printing ink in different colors such as cyan, magenta and yellow. The print head can contain fewer or more than four printing nozzles, however. The first printing nozzle, which is connected to the printing means supply for a security imprint, is expediently arranged spatially separated from the other printing nozzles in the print head. In such an arrangement, it is possible in particular to assign the first nozzle to the first printing area with the security imprint and correspondingly the second and any additional printing nozzles to the second printing area, all the printing nozzles printing only in the printing area spatially assigned to them. In this manner it can be guaranteed that the printing nozzle connected to the printing means supply for the security imprint prints only in the first printing area, which contains the security imprint, and that the second printing nozzle and any additional printing nozzles, which are each connected to the printing means supply or additional printer means supplies with conventional printing ink, print only the second printing area reserved for the text or image imprint. Thereby an overlapping of the different printing areas can be avoided.

### BRIEF DESCRIPTION OF THE DRAWINGS

These and further advantages of the invention follow from the embodiment of the invention described below with reference to the accompanying drawings. The drawings show:

FIG. 1: perspective representation of a device according to the invention for printing mailpieces, in a first embodiment;

FIG. 2: perspective representation of a device according to the invention for printing mailpieces, in a second embodiment;

FIG. 3: representation of the device from FIG. 2 in a view rotated by 90°;

FIG. 4: schematic representation of the print head of a device according to the invention in the embodiment of FIG. 1;

FIG. 5: schematic representation of the print head of a device according to the invention in the embodiment of FIG. 2.

### DETAILED DESCRIPTION OF THE INVENTION

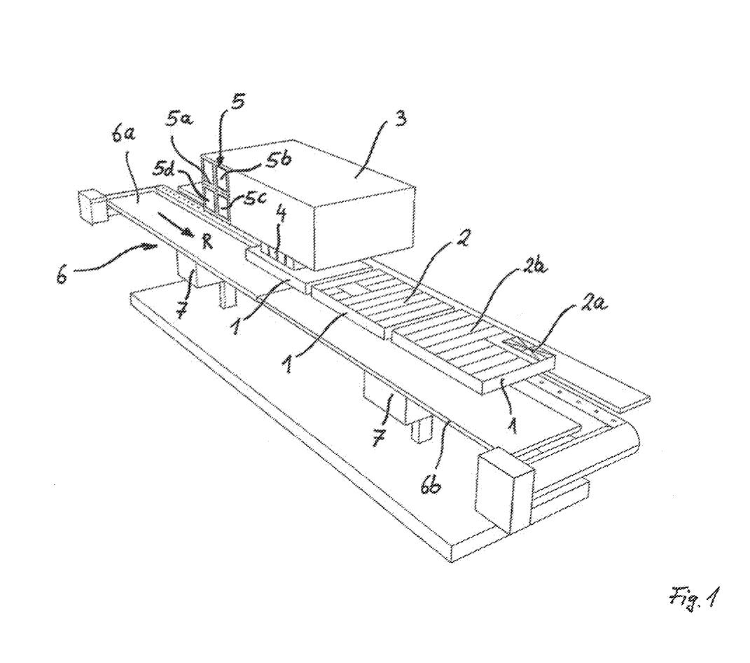

A first embodiment of a device according to the invention for printing mailpieces is shown in FIG. 1. The mailpieces to be printed can be envelopes on which a recipient and/or sender imprint, possibly with image motifs, and a security imprint such as a franking mark (postage imprint) are to be printed. The device according to the invention can also be used for printing other mailpieces such as postcards or packages. The device is also suitable for printing mailpieces having different geometries and in particular different thicknesses.

The device comprises a transport device 6 and a printer 3, wherein the transport device 6 transports the mailpieces 1 to be printed in a transport direction R, which is collinear with the transport device 6, to the printer 3 and away from the printer 3 after printing. The transport device 6 is also advantageously movable with respect to its position in the direction orthogonal to the printer 3, in order to be able to adjust a suitable distance relative to the printer 3 for printing the mailpieces 1 on the transport device 6. In the embodiment shown here, the transport device 6 has a first transport unit 6a and a second transport unit 6b, which can be designed for example as transport belts driven by a motor. The two transport units 6a and 6b are advantageously independently height-adjustable in relation to the printer 3 arranged above the transport units 6a, 6b. The transport units 6a, 6b are each coupled to a drive unit 7 for height adjustment relative to the printer 3. The drive units 7 can be a servomotor, with which the height of the transport units 6a, 6b relative to the print head 3 can be adjusted, in order to bring the mailpieces 1 on the transport units 6a, 6b to a distance from the printer 3 suitable for printing.

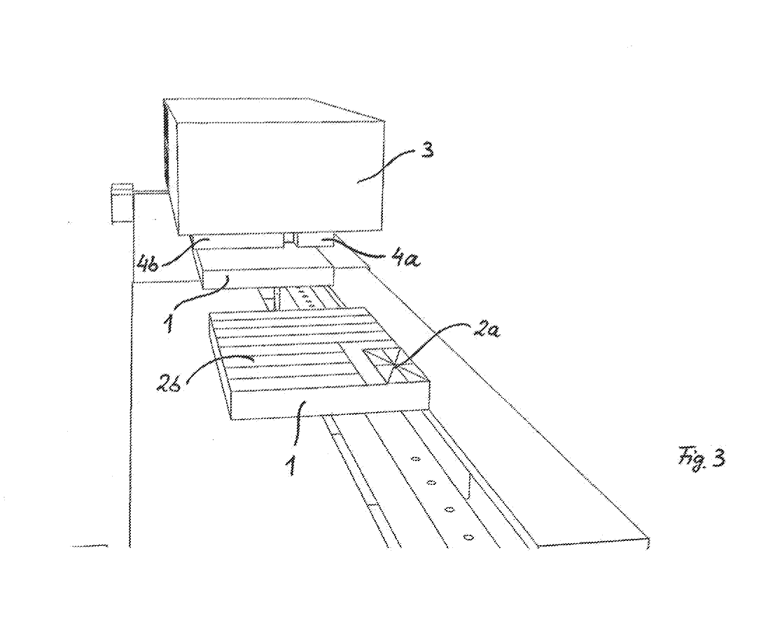

The printer 3 schematically shown in FIG. 3 has a housing in which a print head 4 and several removable cartridges 5 are arranged. In particular, the print head 4 can be an inkjet print head. The print head 4 comprises several printing nozzles 4a, 4b, 4c, 4d, which are arranged on the underside of the printer 3. The cartridges 5, which can removed from the printer 3, each contain a printing means supply 5a, 5b, 5c, 5d. Each printing means supply 5a-5d is connected to an associated printing nozzle 4a-4d, by a supply line for example.

The print head 4 comprises a first printing nozzle 4a and additional printing nozzles 4b-4d. The first printing nozzle 4a is connected to the first printing means supply 5a. An ink suitable for a security imprint, such as a franking mark, and specially certified therefore if necessary, is contained in the first printing means supply 5a. The ink suitable for a security imprint can be a fluorescent ink, for example, which is used in franking machines for printing a franking mark. Conventional printing ink, of the type used for example in inkjet printers, is contained in the other printing means supplies 5b, 5c, 5d.

The device shown in FIG. 1 further comprises a not-shown control unit here as well as a first data processing unit and a second data processing unit, which are likewise not shown. The control unit is used for separate controlling of the first printing nozzle 4a and the additional printing nozzles 4b-4d of the print head 4. The control unit is coupled for this purpose to the first data processing unit and the second data processing unit. The first data processing unit includes the data-technology functionality of a franking machine. In particular, it contains counting means and a postage loading unit. The counting means that are contained in the first data processing unit comprise for example a balance counter, which can be loaded with a postage balance by telephone, prepaid card or via a data line to a postal authority. This balance counter displays the balance of the postage that has been loaded. The counting means of the first data processing unit expediently further comprises a sum counter that contains the total sum of postage and displays the total postage that has been used by the franking unit of the device according to the invention. The counting means expediently further comprises a third counter that counts the number of franking marks printed with the franking device.

The second data processing unit, which is separate from the first data processing unit at least logically, but preferably also physically for security reasons, contains the printing data for a text or image print to be applied to the mailpieces. This data can be, for example, the address data for the recipient addresses of the mailpieces and, if applicable, text or image motifs to be printed in addition to the recipient address. The text or image imprint to be printed on the mailpieces can in particular also contain bar codes for assigning the mailpieces, the assignment taking place via a database stored in the second data processing unit containing sending information in addition to the recipient address, for example, data about the type of sending to be chosen (postcard, letter, registered, express, package, etc.) or the delivery service to be used for subsequent sending of the mailpieces (for example the German Federal Post Office or a private postal company).

The printing data necessary for the security imprint such as a franking mark and for the text or image imprint is transmitted by the first data processing unit and the second data processing unit to a central control unit. The printing data is processed in the central control unit in order to generate an overall print image to be printed on the mailpieces. The overall print image is referred to here as imprint 2 and is composed of a first printing area 2a, which contains a security imprint, and a second printing area 2b, which contains a text or image imprint. An individual imprint 2 is to be printed on each individual mailpiece, because each of the mailpieces differs at least with respect to the recipient address to be printed and possibly with respect to data of the security imprint to be printed, for example, postage to be printed for the subsequent sending of the respective mailpiece. The print data which the control unit receives from the first and second data processing units is processed in a printing preparation software in such a manner that the overall imprint 2 is subdivided into subregions, namely the first printing area 2a and the second printing area 2b, without any overlapping of the two printing areas 2a and 2b. This is necessary, for example, if the security imprint contained in the first printing area 2a is a franking mark that must be applied according to the franking conditions of the postal authority at a defined point on the mailpiece 1.

In order to satisfy the security requirements for printing a security imprint, the printing data prepared in the central control unit to form the overall imprint 2 is separated into printing commands for the first printing nozzle 4a, which is assigned to the first printing area 2a, and for the other printing nozzles 4b, 4c and 4d, which are assigned to the second printing area 2b. The division of the printing data for the first printing nozzle 4a and the other printing nozzles 4b-4d enables printing of the security imprint in the first printing area 2a and of the text or image imprint in the second printing area 2b to be done with separate data processing, but simultaneously. For this purpose, the central control unit routes the printing data for the first printing area 2a to the first printing nozzle 4a and the printing data for the second printing area 2b to the printing nozzles 4b-4d and controls the printing nozzles in such a manner that both printing areas 2a and 2b can be printed simultaneously, i.e. in a single print run, onto the respective mailpiece 1. During printing of the imprint 2 by the print head 4, the mailpiece 1 to be printed moves under the printer 3 in the transport direction R at a suitable distance from the stationary print head 4. The entire imprint 2 is printed onto the mailpiece 1 in a single print run, i.e., the mailpiece 1 has the entire imprint 2, composed of the first printing area 2a and the second printing area 2b, on its printed surface after a single run through the printer 3. Reversing and another pass through the printer 3 by a mailpiece is no longer necessary.

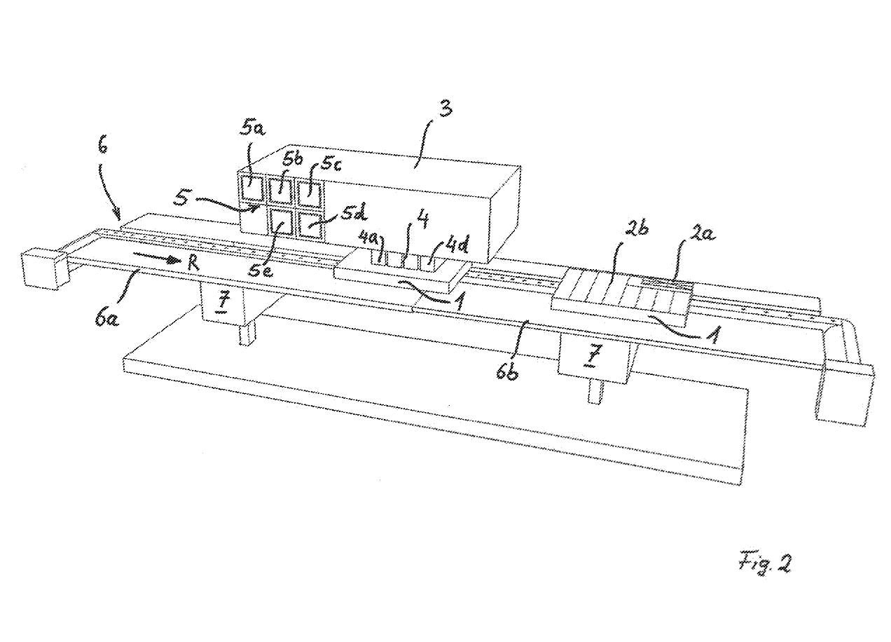

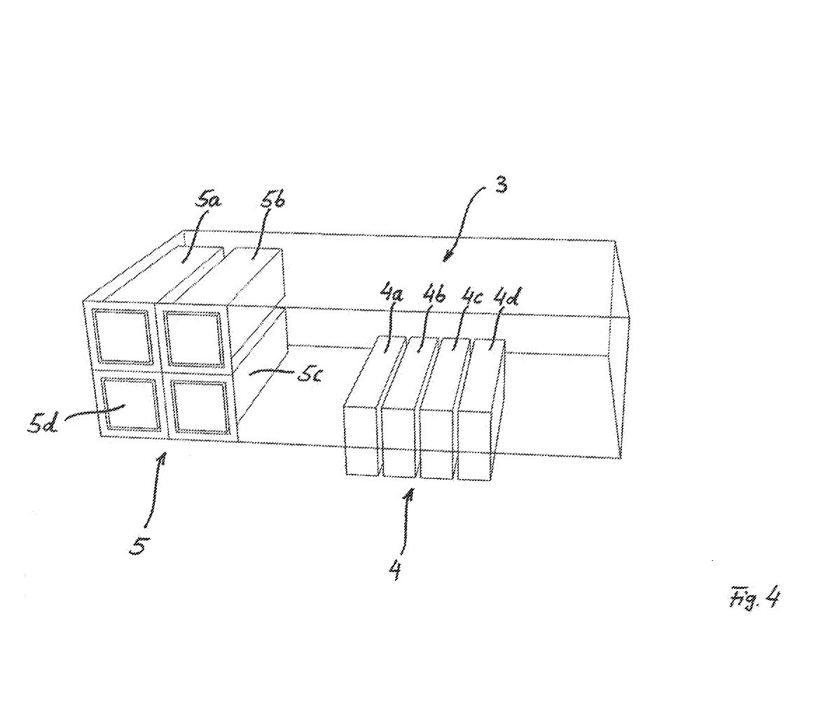

A second embodiment of the device according to the invention is shown in FIGS. 2 and 3. It coincides with the arrangement in FIG. 1 with respect to the structure of the transport device 6. The printer 3 of this embodiment, which is schematically shown in FIG. 4, comprises a total of five printing means supplies 5a-5e as well as five printing nozzles 4a-4e, a printing means supply 5a-5e being assigned to each printing nozzle 4a-4e. The print head 4 contains a first printing nozzle 4a, which is connected to a first printing means supply 5a, which contains ink suitable for a security imprint. The additional printing nozzles 4b-4e are each connected to a printing means supply 5b-5e, in each of which a conventional printing ink in different colors is contained. The printing means supplies 5b-5e expediently contain ink with four different colors such as cyan, magenta, yellow and black. The ink contained in the first printing means supply 5a and suitable for a security imprint expediently has a different color such as a fluorescent red or a blue suitable for printing a franking mark.

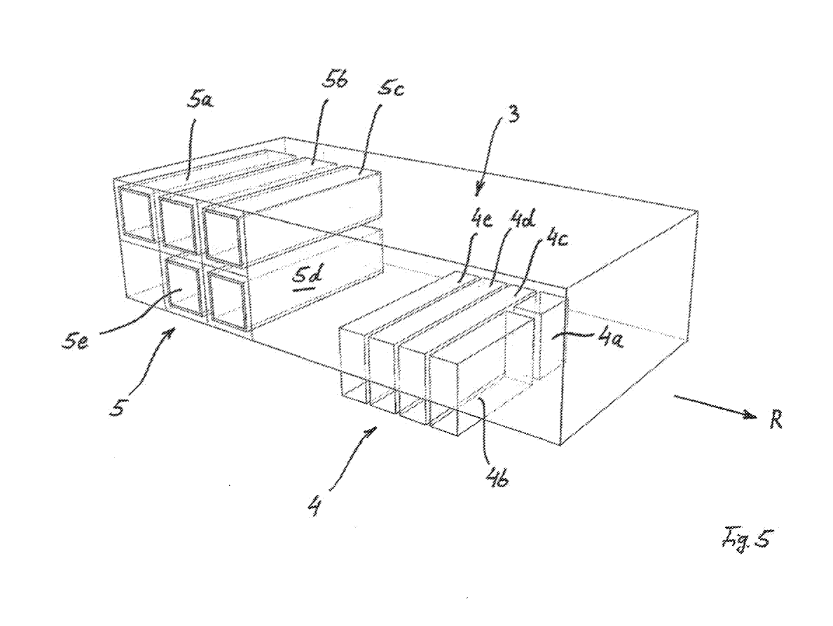

As is seen from the illustration of FIG. 5, the printing nozzles are arranged sequentially in the transport direction R. The extent of the printing nozzles 4c-4e in the transverse direction substantially corresponds to the format (width) of the mailpieces 1 to be printed. The first printing nozzle 4a is preferably spatially separated from the other printing nozzles 4b-4e. The extent of the printing nozzle 4a in the direction transverse to the transport direction R corresponds to the extent of the first printing area 2a in this direction on the mailpieces 1. This geometric configuration defines a correlation of the first printing nozzle 4a and the first printing area 2a. It is guaranteed in this manner that the first printing nozzle, with which the security imprint is printed in the designated printing area 2a, can print only in this printing area 2a, but not in the other printing area 2b.

An embodiment in which a conventional print head for a 4-color inkjet printer is used, wherein the printing nozzle 4a provided for the black printing is connected to a printing means supply 5a for a security imprint, instead of a printing means supply for black ink, has proven particularly expedient. The other printing nozzles 4b-4d of this 4-color inkjet printer are then connected—as in a conventional 4-color inkjet printer—to a printing means supply 5b-5d which contains conventional inks in different colors (cyan, magenta and yellow).

In this embodiment of the device according to the invention it is necessary to print the parts of the second printing area 2b that require black ink either with a different color than black via an image processing software or to print these black areas by means of the three color printing nozzles 4b-4e.

The invention is not limited to the embodiments described in detail. In an embodiment not shown here, it is provided that the printed imprint 2 is subjected to a check by means of a print testing unit after printing of the mailpieces 1. The print testing unit comprises an optical sensor for this purpose, with which the printed mailpieces 1 are scanned in order to detect the imprint 2. The imprint 2 captured by the optical scanner is compared in a data processing unit to a target imprint to be printed onto the respective mailpiece. If deviations are found in this comparison of the captured imprint 2 to the target imprint, the mailpiece 1 in question can be sorted out by means of an appropriate device and if necessary re-created. If a security imprint in the form of a franking mark is printed on the mailpiece 1 in question and a deviation is found in the respective mailpiece during the comparison of the detected imprint 2 to the target imprint, and the mailpiece therefore has been sorted out, it is possible in this embodiment to refund the postage printed on the respective mailpiece via a coupling of the print testing unit to the counting means contained in the first data processing unit.

All references cited herein are expressly incorporated by reference in their entirety. In addition, unless mention was made above to the contrary, it should be noted that all of the accompanying drawings are not to scale. There are many different features to the present invention and it is contemplated that these features may be used together or separately. Thus, the invention should not be limited to any particular combination of features or to a particular application of the invention. Further, it should be understood that variations and modifications within the spirit and scope of the invention might occur to those skilled in the art to which the invention pertains. Accordingly, all expedient modifications readily attainable by one versed in the art from the disclosure set forth herein that are within the scope and spirit of the present invention are to be included as further embodiments of the present invention.

What is claimed is:

1. Device for printing mailpieces with an imprint that contains a first printing area with a security imprint and a second printing area with a text or image imprint, the device comprising a printer with a print head, wherein the print head comprises at least two printing nozzles, of which a first printing nozzle is connected to a first printing means supply and a second printing nozzle is connected to a second printing means supply, wherein the first printing means supply and the second printing means supply are separate from one another, and the first printing means supply contains an ink suitable for a security imprint and the second printing means supply contains conventional printing ink.

2. Device according to claim 1, wherein the printing nozzles simultaneously print the first printing area and the second printing area during the print run.

3. Device according to claim 1, wherein the first printing nozzle is assigned to the first printing area, and the second printing nozzle and any additional nozzles are assigned to the second printing area, each of the printing nozzles printing only in the printing area assigned to it.

4. Device according to claim 1, wherein the printing nozzles are inkjet printing nozzles, and the printing means supply for the security imprint contains an ink certified for printing a security imprint.

5. Device according to claim 1, wherein the print head is a print head of an inkjet printer with five printing nozzles, wherein the first printing nozzle is connected to the printing means supply for the security imprint and is arranged in the print head spatially separated from the other printing nozzles.

6. Device according to claim 1, wherein the print head is a four-color print head for an inkjet printer, in which the printing nozzle for printing black is connected to the printing means supply for the security imprint.

7. Device according to claim 1, wherein the control unit is coupled to a first data processing unit in order to receive the franking information relevant to printing the first printing area therefrom.

8. Device according to claim 1, wherein the control unit is coupled to a second data processing unit in order to receive the printing information relevant to printing the second printing area therefrom.

9. Device according to claim 1, wherein the security imprint is a franking mark and a counting means is provided for detecting the postage printed with the franking mark.

10. Device according to claim 1, wherein a print testing unit is provided that scans the finished printed mailpieces in order to capture the imprint and compare it to a target imprint.

11. Device according to claim 7, wherein the first data processing unit contains the counting means and a postage loading unit.

12. Device for printing mailpieces with an imprint that contains a first printing area with a security imprint and a second printing area with a text or image imprint, comprising a printer with a print head having at least two printing nozzles, of which a first printing nozzle is connected to a first printing means supply for a security imprint, and a second printing nozzle is connected to a second printing means supply for a text or image imprint, wherein in order to print a mailpiece, it is moved in a print run relative to the print head, and the printer is coupled to a control unit in order to control the printing nozzles, wherein the control unit controls the printing nozzles in such a manner that the entire imprint is printed onto the mailpiece in a single print run.

13. Method for printing mailpieces with an imprint that contains a first printing area with a security imprint and a second printing area with a text or image imprint, wherein, when a mailpiece is being printed, it is moved in a print run relative to a print head having at least two printing nozzles, of which a first printing nozzle is connected to a first printing means supply for a security imprint and a second printing nozzle is connected to a second printing means supply for a text or image imprint, and the printing nozzles of the print head are controlled by a control unit in such a manner that the entire imprint is printed onto the mailpiece in a single print run.

14. Method according to claim 13, wherein a print testing unit is provided that scans the finished printed mailpieces in order to capture the imprint and compare it to a target imprint.

15. Method according to claim 14, wherein the printed mailpiece is sorted out if a deviation is found in the comparison of the captured imprint to the target imprint.

16. Method according to claim 15, wherein the print testing unit is coupled to the counting means and refunds the postage for a given mailpiece if a deviation is found for this mailpiece in the comparison of the captured imprint to the target imprint and the mailpiece has been sorted out.

17. Method according to claim 13, wherein the printing nozzles simultaneously print the first printing area and the second printing area during the print run.

18. Method according to claim 13, wherein the first printing nozzle is assigned to the first printing area, and the second printing nozzle and any additional nozzles are assigned to the second printing area, each of the printing nozzles printing only in the printing area assigned to it.

19. Method according to claim 13, wherein the control unit is coupled to at least one of: a first data processing unit in order to receive the franking information relevant to printing the first printing area therefrom; and a second data processing unit in order to receive the printing information relevant to printing the second printing area therefrom.

20. Method according to claim 13, wherein the security imprint is a franking mark and a counting means is provided for detecting the postage printed with the franking mark.
